(19) United States
(12) Patent Application Publication
(10) Pub. No.: US 2024/0270094 A1
(43) Pub. Date: Aug. 15, 2024

(54) ELECTRIC VEHICLE CHARGING STATION AND ELECTRIC VEHICLE WITH DUAL CHARGING

(71) Applicant: EVJAM LLC, Minneapolis, MN (US)

(72) Inventors: Steven DICKE, Minneapolis, MN (US); Gregg KROMREY, Hudson, WI (US)

(73) Assignee: EVJAM LLC, Minneapolis, MN (US)

(21) Appl. No.: 18/440,847

(22) Filed: Feb. 13, 2024

Related U.S. Application Data
(60) Provisional application No. 63/445,069, filed on Feb. 13, 2023.

(51) Int. Cl. B60L 53/16

(52) U.S. Cl. CPC B60L 53/16; B60L 2210/10; B60L 2210/20; B60L 2210/30

(57) ABSTRACT

One example provides an electric vehicle charging station including at least two AC-AC converters each providing an AC charging output, at least two AC-DC converters each providing a DC charging output, a plurality of electrical contacts, each controllably operable between an open and a closed position and disposed in electrical pathways between the AC-AC converters and at least charging plug and between the AC-DC converters and the at least one charging plug, and a controller to control the positions of the electrical contacts to selectively provide the AC charging output of each of the at least two AC-AC converters to the at least one charging plug or to provide the DC charging output of each of the at least two DC-DC converters to the at least one charging plug to provide dual AC or DC charging of an electric vehicle to be charged via the at least one charging plug.

### CROSS REFERENCE TO RELATED APPLICATION

This Non-Provisional Patent application claims the benefit of the filing date of U.S. Provisional Patent Application Ser. No. 63/445,069, filed Feb. 13, 2023, which is herein incorporated by reference.

### TECHNICAL FIELD

The present disclosure relates generally to examples of electric vehicles and to devices for use with an electric vehicle, including electric vehicle batteries and electric vehicle charging systems and devices.

### BACKGROUND

Electric vehicles and electric vehicle devices provide quiet, clean, and efficient powertrains for moving from place to place or for getting work done.

For these and other reasons, there is a need for the present invention.

### SUMMARY

The present disclosure provides one or more examples of an electric vehicle and systems and/or devices for use with an electric vehicle. In one or more examples, the system is an electric vehicle charging system and/or charging device.

Additional and/or alternative features and aspects of examples of the present technology will become apparent from the following description and the accompanying drawings.

### BRIEF DESCRIPTION OF THE DRAWINGS

The Figures generally illustrate one or more examples of an electric vehicle and/or devices for use with an electric vehicle such as electric vehicle batteries or electric vehicle charging systems and devices.

FIG. 1 is a block and schematic diagram generally illustrating an EV charging station and electrical vehicles, according to one example.

FIG. 1A is a schematic diagram generally illustrating an example of a charging plug.

FIG. 2 is a block and schematic diagram generally illustrating an EV charging station and electrical vehicle, according to one example.

FIG. 3 is a block and schematic diagram generally illustrating an EV charging station and electrical vehicles, according to one example.

FIG. 3A is a schematic diagram generally illustrating an example of a charging plug.

FIG. 4 is a block and schematic diagram generally illustrating an EV charging station and electrical vehicle, according to one example.

FIG. 5 is a schematic diagram generally illustrating an EV charging plug, according to one example.

FIG. 6A is a block and schematic diagram generally illustrating an EV charging station, according to one example.

FIG. 6B is a block and schematic diagram generally illustrating an EV charging station, according to one example.

FIG. 6C is a block and schematic diagram generally illustrating an EV charging station, according to one example.

FIG. 7A is a block and schematic diagram generally illustrating an electric vehicle, according to one example.

FIG. 7B is a block and schematic diagram generally illustrating an electric vehicle, according to one example.

FIG. 7C is a block and schematic diagram generally illustrating an electric vehicle, according to one example.

FIG. 8A is a block and schematic diagram generally illustrating an EV charging station and electrical vehicles, according to one example.

FIG. 8B is a block and schematic diagram generally illustrating an EV charging station and electrical vehicle, according to one example.

FIG. 8C is a schematic diagram generally illustrating a perspective view of a piggyback EV charging plug, according to one example.

FIG. 8D is a schematic diagram generally illustrating a side view of a piggyback EV charging plug, according to one example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

Electric vehicles (EVs), such as automobiles (e.g., cars and trucks), autonomous vehicles, snowmobiles, personal watercraft (PWC), all-terrain vehicles (ATVs), side-by-side vehicles (SSVs), and electric bikes, for example, offer a quiet, clean, and more environmentally friendly option to gas-powered vehicles. Electric vehicles have electric powertrains which typically include a battery system, one or more electrical motors, each with a corresponding electronic power inverter (sometimes referred to as a motor controller), and various auxiliary systems (e.g., cooling systems).

### Electric Vehicle Charging System

The present disclosure provides an EV charging system including an EV charging station and/or an EV, wherein the charging station employs multiple (at least two) power converters (e.g., at least two DC-DC power converters and/or at least two AC-AC power converters), and wherein the EV charging station can be configured (e.g., via contactors controlled by a charging station controller) so that each power converter can separately charge individual EVs, or can be configured so that the power converters can together simultaneously charge a single EV (a so-called dual charging procedure). When a dual-charging operation is carried out, in some examples, the EV may be configured to separate or partition the battery into sub-partitions (e.g., via contactors controlled by a vehicle control unit (VCU), with each of the multiple power converters separately charging a different one of the battery sub-partitions during the dual-charging operation. In other examples, rather than partitioning the battery, the charging outputs of the multiple power converters are arranged in parallel with one another to charge the battery as a whole (i.e., the battery is not partitioned).

Partitioning the EV's battery into separate partitions which are separately and simultaneously charged reduces the time required to charge the EV's battery.

In one example, the EV charging system may include a pair of AC-DC converters (of any suitable voltage). In one example, each of the AC-DC converters may separately provide DC fast charging to separate EVs, with each AC-DC converter being separately metered to enable separate billing charges to be assessed to each EV. In another example, each of the AC-DC inverters may simultaneously provide DC fast charging to a same EV, where a first one of pair of the AC-DC converters DC charges a first portion of the EV's battery (a first battery partition) and the second one of the pair of AC-DC converters charges a second portion of the EV's battery (a second battery partition). In such a case, the metering is combined to provide the operator with a single charge ($), where the cost per kWH may be greater for dual-charging than for single-charging.

In other examples, the EV charging station may include multiple AC-AC converters. In other examples, the EV charging station may include multiple DC-DC converters and multiple AC-AC converters. The AC-DC converters and AC-AC converters may be of any suitable voltage and current rating.

One or more examples and features of the charging system are detailed herein and illustrated in the Figures.

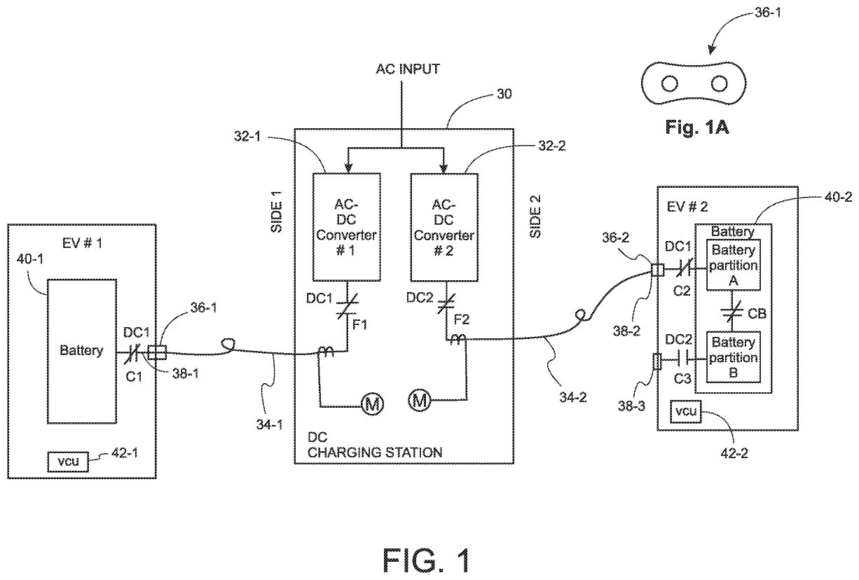

FIG. 1 is a simplified block schematic diagram illustrating a charging station 30, implemented as a DC charging station, having a pair of AC-DC converters 32, illustrated as first AC-DC converter 32-1 and second AC-DC converter 32-2, with each respectively having a set of controllable contacts F1 and F2, and being separately metered by a corresponding meter, M, for billing purposes. In FIG. 1, first and second AC-DC converters 32-1 and 32-2 are illustrated and described as being arranged to individually charge separate electric vehicles (EVs), with first AC-DC converter 32-1 being illustrated as charging a first EV, labeled as EV1, and second AC-DC converter 32-2 being illustrated as charging a second EV, labeled as EV2. In examples, charging station 30 of FIG. 1 may be implemented to provide any suitable DC charging voltage level (e.g., 200 VDC, 300 VDC, 600 VDC, etc.). In some examples, charging station 30 may provide a DC charging voltage level which is user-selectable for a plurality of DC charging voltage levels which charging station 30 is implemented to provide.

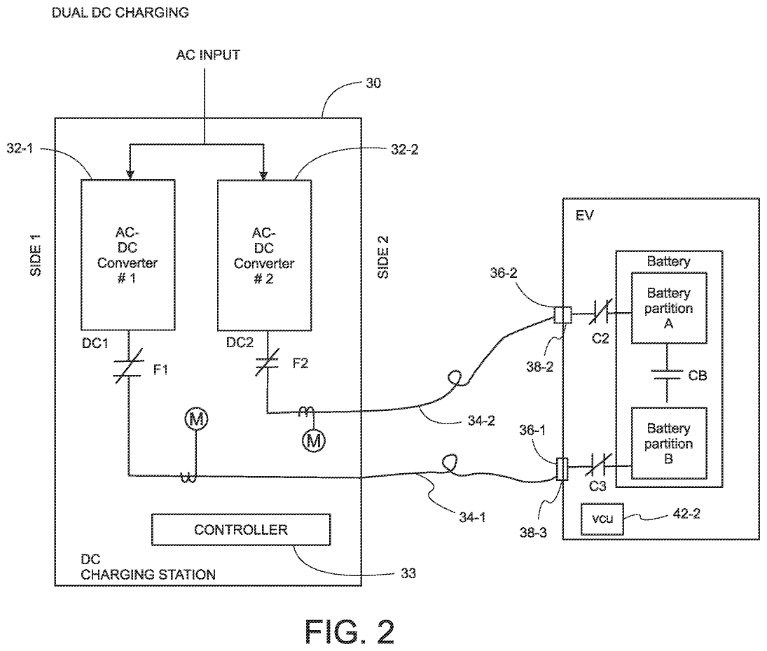

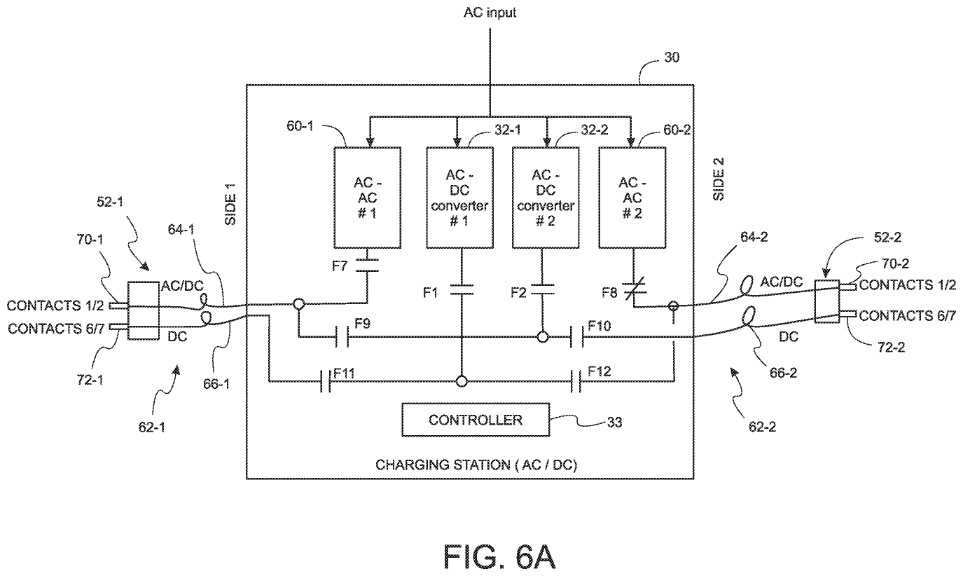

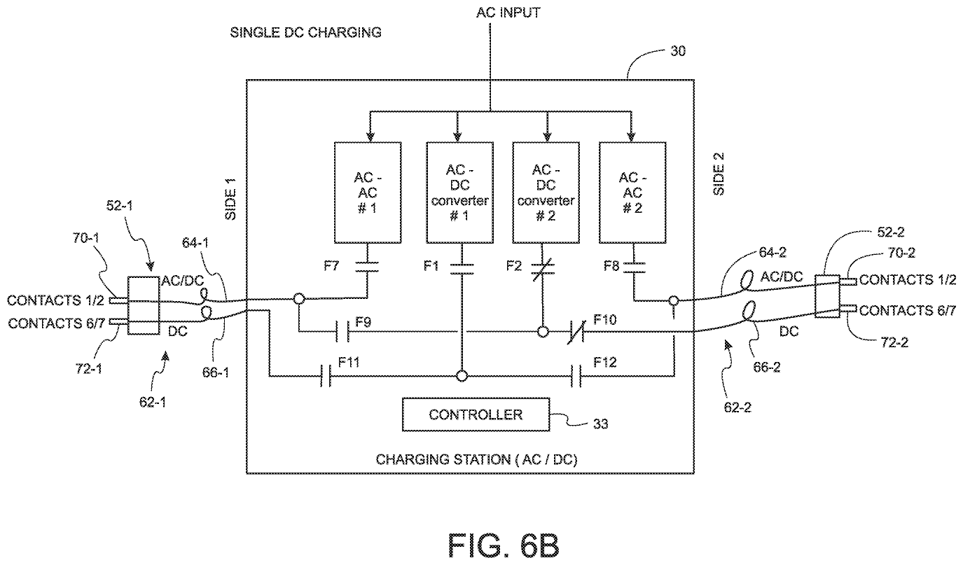

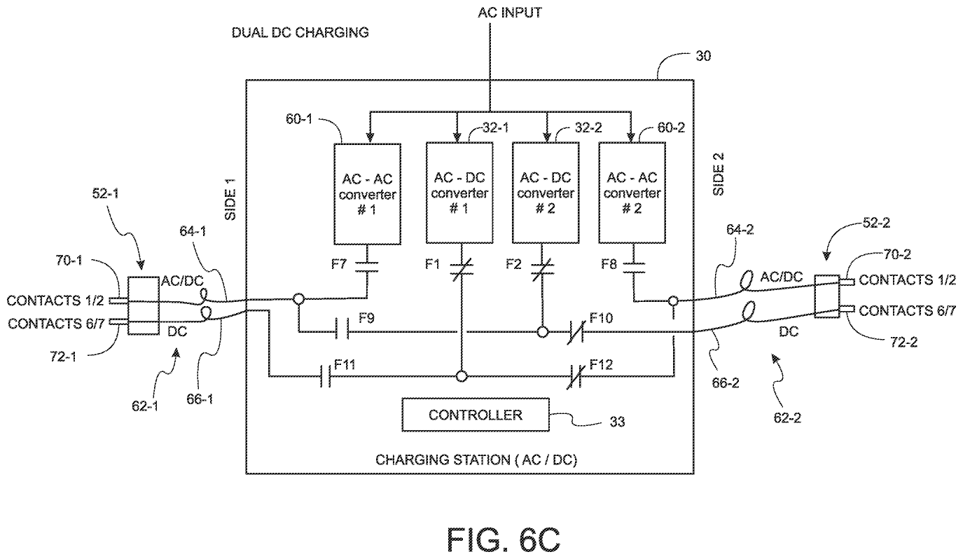

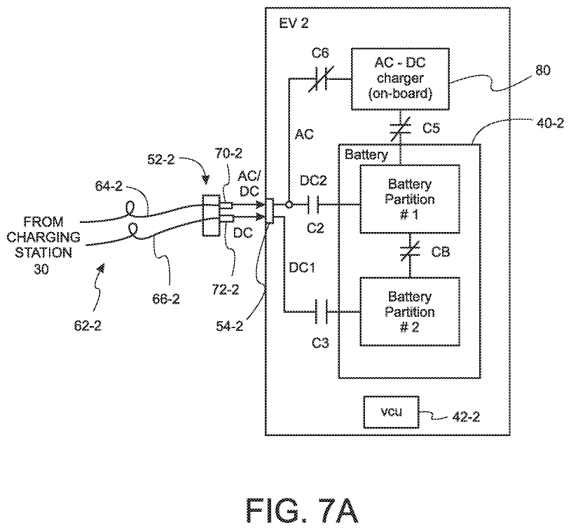

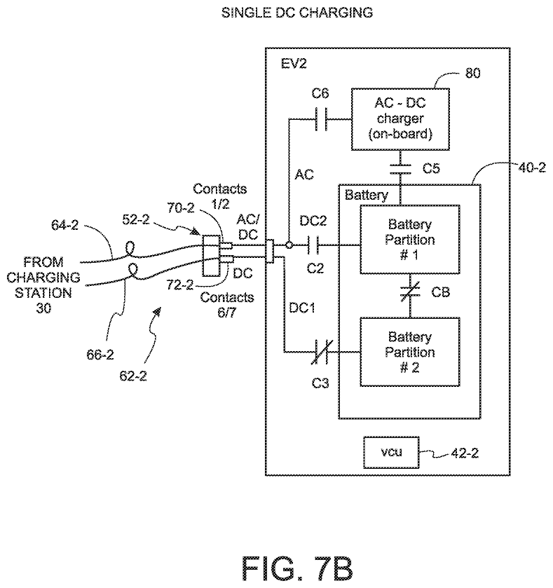

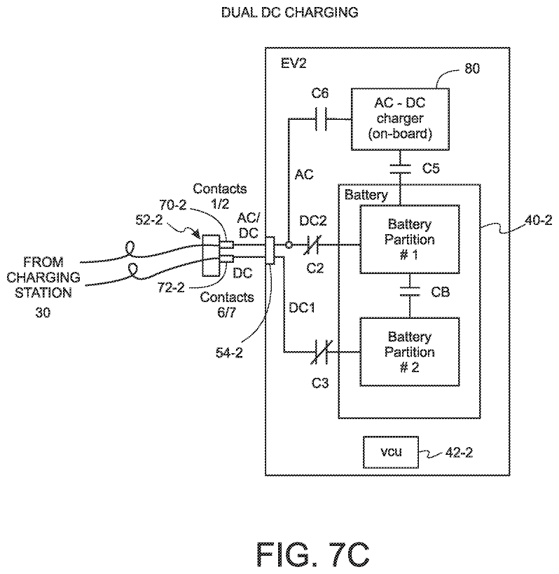

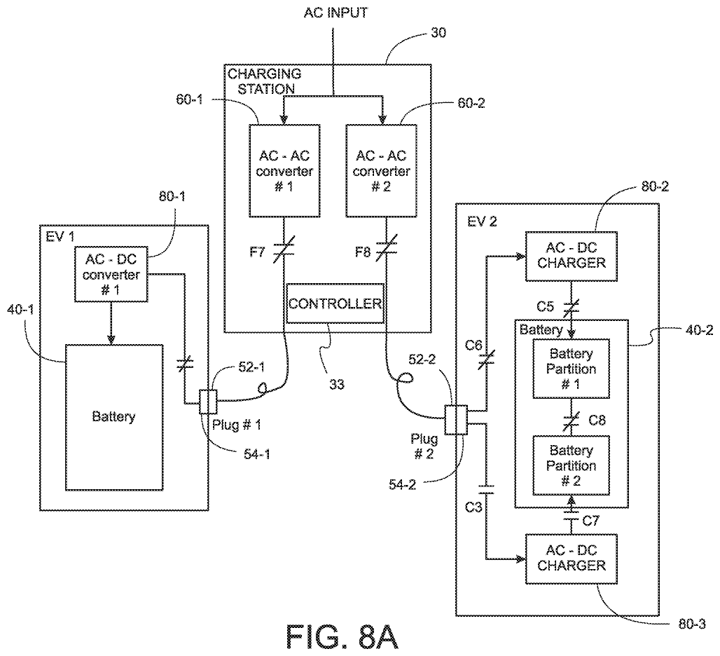

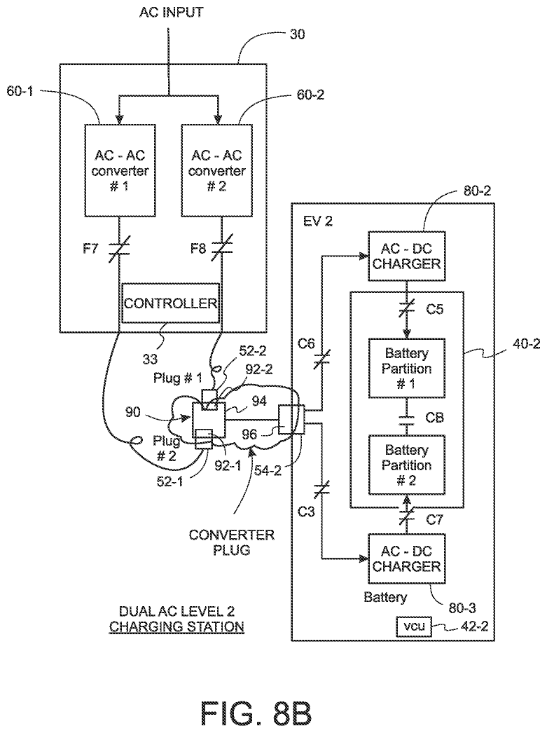

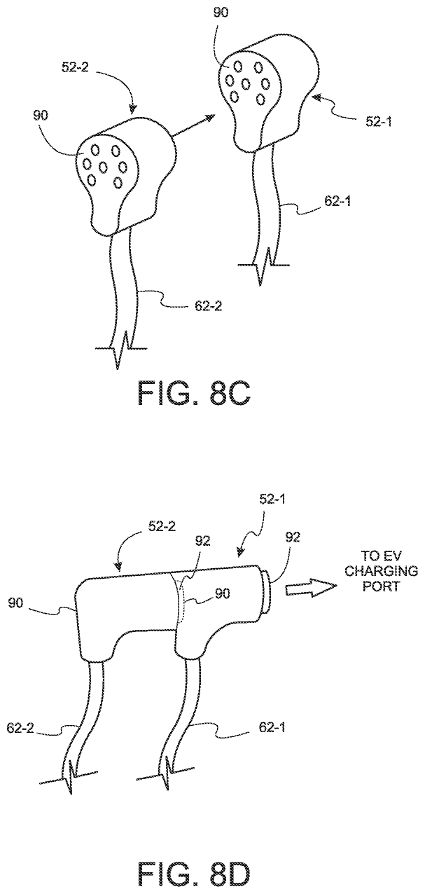

In other examples, as will be described in greater herein, first and second AC-DC converters 32-1 and 32-2 may be arranged to simultaneously charge a single EV (e.g., see FIGS. 2-4). In other examples, charging station 30 may be implemented to provide both AC and DC charging voltages so that, in addition to first and second AC-DC converters 32-1 and 32-2, charging station 30 may be configured with power converters to provide AC and/or DC charging outputs that can be arranged to separately charge different EVs or arranged to simultaneously charge a single EV (e.g., see FIGS. 6A-7C). In other examples, charging station 30, may be implemented as an AC charging station in lieu of a DC charging station, such that charging station 30 is configured to provide AC charging outputs (e.g., Level 1 and Level 2 AC charging) that can be arranged to separately charge different EVs or arranged to simultaneously charge a single EV (e.g., see FIGS. 8A-8B).

Returning to FIG. 1, AC-DC converter 32-1 is illustrated by being coupled via a charging cable 34-1 and a charging plug 36-1 to a charging port 38-1 of EV1, with contacts F1 controllable by a controller 33 to control energization of charging cable 34-1 (where contact F1 is shown in a closed position in FIG. 1). In the example of FIG. 1, EV1 further includes a battery 40-1 in electrical communication with charging port 38-1 via a controllable contact C1 (which is shown in a closed position in FIG. 1). In examples, when charging plug 36-1 of charging cable 34-1 is plugged into charging port 38-1, a vehicle control unit (VCU) 42-1 of EV1 controls charging of battery 40-1 via control of contact C1. In examples, VCU 42-1 communicates with controller 33 of charging station 30 to coordinate charging of EV1, where such communication may occur via wired communication pathways via charging cable 34-1 or wirelessly, for example.

In one example, as illustrated, EV2 includes a battery 40-2 which can be partitioned into a first sub-portion or first battery partition A and a second battery partition B, where battery partitions A and B can be electrically connected and disconnected from one another (“partitioned) via a set of controllable contacts, illustrated as contacts CB, which are controlled via a vehicle control unit (VCU) 42-2. Battery partition A or full battery 34-1 may be electrically connected to a first charging port 38-2 via a set of contacts C2, and battery partition B or full battery 34-1 may be electrically connected to a second charging port 28-3 via set of contracts C3, where contacts C2 and C3 are controlled via VCU 42-2.

In the example of FIG. 1, AC-DC converter 32-2 is illustrated by being coupled via a charging cable 34-2 and a charging plug 36-2 to a charging port 38-2 of EV2, with contacts F2 controllable by a controller 33 to control energization of charging cable 34-2 (where contact F2 is shown in a closed position in FIG. 1). In examples, VCU 42-2 communicates with controller 33 of charging station 30 to coordinate charging of EV2, where such communication may occur via wired communication pathways via charging cable 34-2 or wirelessly, for example. In examples, VCU 42-2 controls battery contacts CB and charging port contacts C2 and C3 based on the monitoring of inputs to charging ports 38-2 and 38-3, on user communications/inputs, and on communications with controller 33. In one example, when charging plug 36-2 of charging cable 34-2 is plugged into charging port 38-2 and is energized by charging station 30 via contact F2, vehicle control unit 42-2 of EV2 controls charging of battery 40-2 by closing battery contacts CB, opening charging port contacts C3 to electrically isolate charging port 38-3, and closing charging port contact C2 to being charging battery 40-2.

FIG. 1A is a schematic diagram generally illustrating an example of plug 36, such as charging plug 36-1, including a positive (+) and negative (−) connection for mating with charging port 38 of an EV, such as charging port 38-1 of EV1. It is noted that plug 36 of FIG. 1A may include additional connections/conductors for signal and data communication between an EV, such as EV1, and a charging station, such as charging station 30.

FIG. 2 is a simplified block and schematic diagram where DC charging station 30 of FIG. 1 is illustrated as operating in a parallel charging mode where first and second AC-DC converters 32-1 and 32-2 are each simultaneously charging separate corresponding battery partitions A and B of battery 40-2 of EV2. As illustrated, first AC-DC converter 32-1 is electrically connected to second charging port 38-3 of EV2 via charging cable 34-1 and charging plug 36-1, and second AC-DC converter 32-2 is electrically connected to a first charging port 38-3 of EV2 via charging cable 34-2 and charging plug 36-2.

As illustrated, contact CB is opened by VCU 42-2 to partition the battery into battery partition A and battery partition B, and contacts C2 and C3 are closed to electrically connect first AC-DC converter 32-1 to charge battery partition B, and to electrically connect second AC-DC converter 32-1 to charge battery partition A. According to such a scenario, battery partitions A & B are charged in parallel to thereby shorten the time to charge the battery of EV2. After the battery is charged, the charging plugs are removed, VCU 42-2 opens contacts C2 and C3 and closes contact CB.

In one case, assuming that battery partitions A & B have the same capacities, using first and second AC-DC converters 32-1 and 32-2 to parallel (or dual) charge battery 40-2 of EV2 cuts the charging time of battery 40-2 in half compared to charging battery 40-2 using only one of the first and second AC-DC converters 32-1 and 32-2. In some instances, an operator may pay an increased cost to dual charge the EV2 using both first and second AC-DC converters 32-1 and 32-2 as compared to charging the vehicle using only one of the first and second AC-DC converters 32-1 and 32-2.

In one case, first and second AC-DC converters 32-1 and 32-2 may be operable to provide user selectable DC charging voltages. For example, in one case, a user of charging station 30 may select the second AC-DC converter 32-2 to output 800 volts and charge battery 40-2 of EV2 using only DC power from second AC-DC converter 32-2 where, during charging, contacts CB and C2 of EV2 are closed, and contact C3 is open. In another case, a user may select first and second AC-DC converters 32-1 and 32-2 to each output 400 volts and charge EV2 using both first and second AC-DC converters 32-1 and 32-2, where during charging contacts C2 and C3 of EV2 are closed and contact CB is open, and charge EV2 using 400 VDC in a same amount of time as charging EV2 using only second AC-DC converter 32-2 operating at 800 VDC. Any suitable voltage level may be employed with 400 VDC and 800 VDC being given as examples for purposes of illustration.

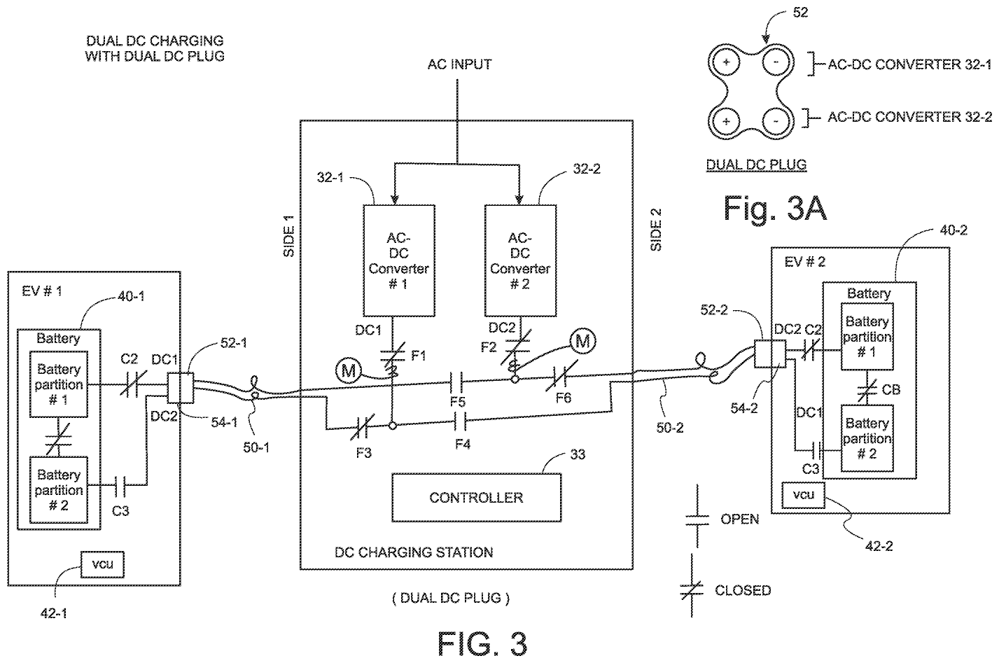

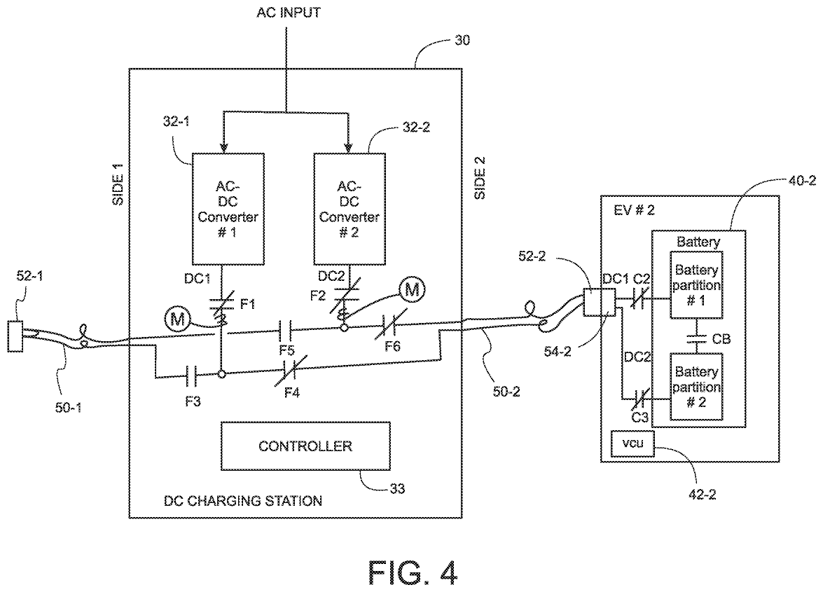

FIGS. 3 and 4 are simplified block and schematic diagrams illustrating charging station 30 of FIG. 1 where first and second AC-DC converters 32-1 and 32-2 can be operated separately or in parallel with one another and be connected to an EV, such as EV1 and EV2, either separately or in parallel, via a single charging cable 50 having a single charging plug 52, as illustrated by charging cable 50-1 having charging plug 52-1 and charging cable 50-2 having charging plug 52-2. In one example, as illustrated, first AC-DC converter 32-1 is connectable to charging plug 52-1 via charging cable 50-1 and controllable contacts F1 and F3, and second AC-DC converter 32-2 is connectable to charging plug 52-1 via charging cable 50-1 and controllable contacts F2 and F5. Similarly, first AC-DC converter 32-1 is connectable to charging plug 52-2 via charging cable 50-2 and controllable contacts F1 and F4, and second AC-DC converter 32-2 is connectable to charging plug 52-2 via charging cable 50-2 and controllable contacts F2 and F6.

FIG. 3A is a schematic diagram generally illustrating an example of plug 52, such as charging plug 52-1 for mating with a charging port 54 of an EV, such as charging port 54-1 of EV1, where plug 52 includes positive (+) and negative (−) connections for both first and second AC-DC converters 32-1 and 32-2.. It is noted that plug 52 of FIG. 3A may include additional connections/conductors for signal and data communication between an EV, such as EV1, and a charging station, such as charging station 30.

In the examples of FIGS. 3 and 4, EV1 and EV2 respectively include batteries 40-1 and 40-2, each of which can be partitioned into battery partitions A and B via a corresponding controllable battery contact CB. EV1 includes a charging port 54-1 which is configured to mate with a plug 52, such as plug 52-1, and which is in electrical communication with battery 40-1 or battery partition A via a controllable contact C1, and in communication with battery 40-1 or battery partition B via a controllable contact C4. EV2 includes a charging port 54-2 which is configured to mate with a plug 52, such as plug 52-2, and which is in electrical communication with battery 40-2 or battery partition A via a controllable contact C2, and in communication with battery 40-2 or battery partition B via a controllable contact C3.

In the example of FIG. 3, first and second AC-DC converters 32-1 and 32-2 are illustrated as separately charging EV1 and EV2. First AC-DC converter 32-1 is connected to charging port 54-1 of EV1 via charging cable 50-1/charging plug 52-1 and closed contacts F1 and F3 (contact F4 is open). In one example, VCU 42-1 of EV1 connects first AC-DC converter 32-1 to battery 40-1 of EV1 for charging by ensuring that battery contact CB is closed, contact C4 is open, and contact C1 is closed (or vice versa). Similarly, second AC-DC converter 32-2 is connected to charging port 54-2 of EV2 via charging cable 50-2/charging plug 52-2 and closed contacts F2 and F6 (contact F5 is open). In one example, VCU 42-2 of EV2 connects second AC-DC converter 32-2 to battery 40-1 of EV2 for charging by ensuring that battery contact CB is closed, contact C3 is open, and contact C2 is closed (or vice versa).

In the example, of FIG. 4, first and second AC-DC converters 32-1 and 32-2 are illustrated as each being connected to EV2 via charging cable 50-2/charging plug 52-2 to simultaneously charge battery 40-2. First AC-DC converter 32-1 is connected to charging port 54-2 of EV2 via charging cable 50-2/charging plug 52-2 and closed contacts F1 and F4 (contact F3 is open). Second AC-DC converter 32-2 is connected to charging port 54-2 of EV2 via charging cable 50-2/charging plug 52-2 and closed contacts F2 and F6 (contact F5 is open). In one example, VCU 42-2 of EV2 opens battery contact CB to partition battery 40-2 into battery partitions A and B, connects second AC-DC converter 32-2 to battery partition A by closing contact C2, and connect first AC-DC converter 32-1 to battery partition B by closing contact C3.

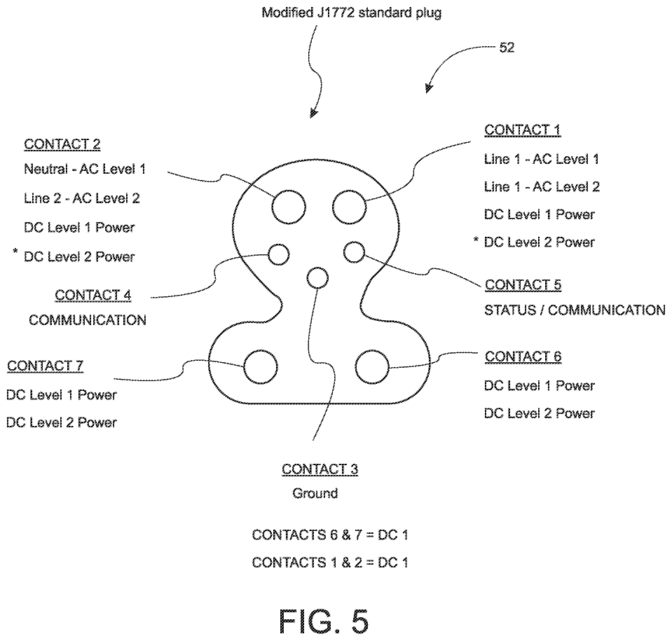

FIG. 5 is a simplified schematic diagram illustrating a modified J1772 standard plug which could be used as the plug for the implementation of single plug 52 of FIGS. 3 and 4. As opposed to the conventional J1772 standard plug, contacts 1 and 2 of the modified plug of FIG. 5 are electrically sized to have voltage and ampere ratings to enable contacts 1 and 2 to be employed to DC fast charging (400 VDC, 800 VDC, etc.), in addition to the conventional uses for AC level 1 and 2 charging.

FIGS. 6A-6C and 7A-7C illustrate examples of charging station 30 where, in addition to providing DC fast charging via first and second AC-DC converters 32-1 and 32-2, charging station 30 is configured to provide AC charging via first and second AC-AC converters/power conditioners 60-1 and 60-2. In examples, as will be described in greater detail below, charging station 30 of FIGS. 6A-6C is configured to provide AC and/or DC charging via a single plug, such as the modified J1772 plug illustrated by FIG. 5.

In the example implementation of FIG. 6A, charging station 30 includes charging cables 62-1 and 62-2, with each charging cable having a respective charging plug 52-1 and 52-2. With further reference to charging plug 52 of FIG. 5, charging plugs 52-1 and 52-2 each include a first pair of contacts corresponding to contacts 1 and 2 of plug 52 (see FIG. 5), illustrated respectively as contacts 70-1 and 70-2, and a second pair of contacts corresponding to contacts 6 and 7 of plug 52 (see FIG. 5), illustrated respectively as contacts 72-1 and 72-2. In examples, each charging cable 62-1 and 62-2 includes a respective first pair of cables 64-1 and 64-2 connected to the respective first pair of contacts 70-1 and 70-2 of respective charging plugs 52-1 and 52-2, and a respective second pair of cables 66-1 and 66-2 connected to the respective second pair of contacts 72-1 and 72-2 of respective charging plugs 52-1 and 52-2. In examples, controller 33 can control controllable contacts F1, F2 and F7-F12 to provide AC or DC charging voltages to the first set of contacts 70-1 and 70-2 of charging plugs 52-1 and 52-2 via the first pairs of charging cables 64-1 and 64-2, and to provide DC charging voltages to the second set of contacts 72-1 and 72-2 of charging plugs 52-1 and 52-2 via the second pairs of charging cables 66-1 and 66-2. It is noted that each of the converters, AC-DC converters 32-1 and 32-2, and AC-AC converters 60-1 and 60-2, may be separately metered for billing purposes (similar to that illustrated by FIG. 1).

In FIG. 6A, charging station 30 is illustrated as providing an AC charging voltage from second AC-AC converter/conditioner 60-2 to the first pair of contacts 70-2 of charging plug 52-2 via first pair of charging cables 64-2, by controller 33 operating to close contact F8 while opening the remaining contacts F1, F2, F7 and F9 to F12.

FIG. 7A corresponds to FIG. 6A, and illustrates an example EV, such as EV2, receiving the AC charging voltage (e.g. Level 2 AC) from AC-AC converter 60-2 via the first set of contacts 70-2 of charging plug 52-2. In one example, as illustrated, EV2 includes battery 40-2 having controllable battery contact CB controllable by VCU 42-2 to partition battery 40-2 into battery partitions A and B. In one example, EV2 further includes an AC-DC charger 80 electrically connectable to battery 40-2 via a controllable contact C5 and to charging port 54-2 via a controllable contact C6. In examples, battery 40-2 or battery partition A is connectable to the first set of contacts 70-2 of plug 52-2 via charging port 54-2 and controllable contact C2, and battery 40-2 or battery partition B is connectable to the second set of contacts 72-2 of plug 52-2 via charging port 54-2 and controllable contact C3. In the example of FIG. 7A, VCU 42-2 operates to open contacts C2 and C3, and to close contacts CB, C5, and C6 to provide the AC charging voltage from the first set of contacts 70-2 of charging plug 52-2 to AC-DC charger 80, and to provide the output of AC-DC charger 80 to battery 40-2 for charging.

In FIG. 6B, charging station 30 is illustrated as providing a DC charging voltage (e.g., 300 VDC fast charge, or other suitable DC voltage) from second AC-DC converter 32-2 to the second pair of contacts 72-2 of charging plug 52-2 via the second pair of charging cables 66-2 of charging cable 62-2, by controller 33 operating to close contacts F2 and F10 while opening the remaining contacts F1, F7-F9, and F11-F12

FIG. 7B corresponds to FIG. 6B, and illustrates an example EV, such as EV2, receiving the DC charging voltage from AC-DC converter 32-2 via the second set of contacts 72-2 of charging plug 52-2. In the example of FIG. 7B, VCU 42-2 operates to open contacts C2, C4, and C5, and to close contacts CB and C3 to provide the DC charging voltage from the second set of contacts 72-2 of charging plug 52-2 to battery 40-2 for charging.

In FIG. 6C, charging station 30 is illustrated as simultaneously providing a DC charging voltages (e.g., 300 VDC fast charge, or other suitable DC voltage) to plug 52-2 from both first and second AC-DC converters 32-1 and 32-2 to parallel charge battery 40-2 of EV2. In one example, as illustrated, first AC-DC converter 32-1 provides a DC charging output to the first pair of contacts 70-2 of charging plug 52-2 via the first pair of charging cables 66-2 of charging cable 62-2, by controller 33 closing contacts F1 and F12, and second AC-DC converter 32-2 provides a DC charging output to the second pair of contacts 72-2 of charging plug 52-2 via the second pair of charging cables 66-2 of charging cable 62-2 by controller 33 operating to close contacts F2 and F10. Controller 33 operates to open contacts F7-F9 and F11.

FIG. 7C corresponds to FIG. 6C, and illustrates an example EV, such as EV2, receiving the DC charging voltages from first and second AC-DC converters 32-1 and 32-2 via the first and second sets of contacts 70-2 and 72-2 of charging plug 52-2. In the example of FIG. 7C, VCU 42-2 operates to open battery contact CB to partition battery 40-2 into battery partitions A and B, and opens contacts C4 and C5 to isolate AC-DC charger 80, and to close contacts C2 and C3 to charge battery partition A via the charging voltage provided by AC-DC converter 32-1 and to charge battery partition B via the charging voltage provided by AC-DC converter 32-2. In other examples, the charging voltages provided by AC-DC converters 32-1 and 32-2 may be provided in parallel to battery 40-2 with battery contract CB closed (so that battery 40-2 is not partitioned during charging). Such parallel charging operations may be referred to as dual-DC fast charging operations.

Although FIGS. 6A-6C and 7A-7C are illustrated and described primarily with respect to plug 52-2, it is noted that charging station 30 can be configured to provide similar implementations with respect to plug 52-1 as well.

FIGS. 8A and 8B illustrated examples of charging station 30 being implemented as a dual-AC charging station (e.g., Level 2 AC) having first and second AC-AC converters/power conditioners 60-1 and 60-2, where the first and second AC-AC converters 60-1 and 60-2 can be configured to separately charge first and second electric vehicles EV 1 and EV 2 (see FIG. 8A), or be used in tandem to parallel charge a single electric vehicle, such as EV 2 (see FIG. 8B).

In some examples, with reference to FIG. 8B, when using the dual charge option, the EV2 may be configured with two separate charging ports (not illustrated) with each charging port to separately receive the charging plugs 36-1 and 36-2 corresponding to first and second AC-AC converters 60-1 and 60-2 (similar to that illustrated by FIG. 2). In some examples, when using the dual charge option, each of the first and second AC-AC converters may employ single charging plugs 52-1 and 52-2 (such as the modified standard J1772 of FIG. 5, where contacts 1 & 2 are used for AC-AC converter #1 and contacts 5 & 6 are used for AC-AC converter #2), with contacts F7 and F8 of charging station 30 and controllable contacts CB, C3, C5, and C6 configured to route the AC power from first and second AC-AC converters 60-1 and 60-2 to battery partitions A and B of EV2 (similar to illustrated and described by FIG. 4, for example).

In one example, as illustrated, a plug adapter 90 may be employed, wherein the plugs 52-1 and 52-2 corresponding to first and second AC-AC converters 60-1 and 60-2 each plug into respective receptacles 92-1 and 92-2 in an adapter body 94. A single charging plug 96 extending from adapter body 94, in turn, plugs into and routs the AC charging outputs from first and second AC-AC converters 60-1 and 60-2 to charging port 54-2 of EV2.

In one example, as illustrated, each battery partition A and B has a respective AC-DC charger for charging battery partitions A and B from respective AC charging inputs from AC-AC converters 60-1 and 60-2 when battery contact CB is open. In other examples, not illustrated, battery 40-2 does not include a battery contact CB (i.e., is non-partionable) and EV2 includes only a single AC-DC charger, such as AC-DC charger 80-2, wherein the AC charging outputs from AC-AC converters 60-1 and 60-2 are provided in parallel to the single AC-DC charger 80-2 to charge battery 40-2 of EV2.

According to the examples of FIGS. 8A and 8B, first and second AC-AC converters 60-1 and 60-2 of charging station 30 may be used to separately charge two EVs, such as EV1 and EV2, or may be arranged in parallel to simultaneously charge the battery of a single EV, such as EV2. In some parallel charging examples, the AC charging outputs of first and second AC-AC converters 60-1 and 60-2 may be arranged in parallel to simultaneously charge the battery 40-2 as a whole, or may be arranged to separately charge respective battery partitions A and B of battery 40-2 via corresponding AC-DC chargers 80-2 and 80-3.

When charging in dual charging mode, an electric vehicle may be able to charge its battery is less time than when the vehicle is charged using single-mode charging (i.e., using only one of the first and second AC-AC converters 60-1 and 60-2). The dual AC charging station 30 of FIGS. 8A and 8B, or other similar charging station configurations, may be particularly suited for use in a residential dwelling environment (e.g., in a residential garage).

With reference to FIGS. 8C and 8D, in one example, in lieu of using an plug adapter 90 to parallel the outputs of AC-AC converters 60-1 and 60-2, charging plugs, such as charging plugs 52 of FIG. 5, are implemented with a piggy-back configuration when a second plug, such as plug 52-2, can plug into the back of a first plug, such as plug 52-1, while the first plug is plugged into the charging port of an EV, such as first plug 52-1 being plugged into charging port 54-1 of EV1 (see FIG. 8A, for example). FIGS. 8C and 8D respectively illustrate simplified perspective and side views of an example of such a piggy back plug configuration. In one example, each plug 52 has a receptacle 90 on the back side which is configured to receive the plug connectors 92 of the plug to be piggybacked thereon. For instance, according to one example, each charging plug 52 has a male plug 92 configured to be received into a charging port of an electric vehicle, such as charging port 54-1 of EV1, and a female port 90 configured to receive the male plug of another charging plug 52, such as a male plug of charging plug 52-2 being plugged into a female port of charging plug 52-1, with the male plug of charging plug 52-1 being plugged into an EV charging port, such as into charging port 54-1 of EV1. In examples, charging plug 52 includes a removable cap to cover female charging port 90 when not being used.

It is noted that the conductors of the stackable or piggy-back charging plugs 52 would be constructed with voltage and ampacity ratings as necessary to accommodate parallel charging operations. It is further noted that any suitable connector configuration, including any number of known standard plug configurations, may be employed for charging plugs, charging ports, plug adapters, and stackable or piggyback plugs described in the present disclosure.

It is recognized that the charging system of the present disclosure can be configured for use in many charging system applications, including those not disclosed herein.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

The claims are part of the specification.

1. An electric vehicle charging station comprising:
at least two AC-AC converters each providing an AC charging output;
at least two AC-DC converters each providing a DC charging output;
a plurality of electrical contacts, each controllably operable between and open and a closed position, the electrical contacts disposed in electrical pathways between the AC-AC converters and at least charging plug and between the AC-DC converters and the at least one charging plug; and
a controller to control the positions of the electrical contacts to selectively provide the AC charging output of each of the at least two AC-AC converters to the at least one charging plug or to provide the DC charging output of each of the at least two DC-DC converters to the at least one charging plug to selectively provide dual AC or DC charging of an electric vehicle to be charged via the at least one charging plug.

2. The electric vehicle charging station of claim 1, wherein the input data comprises input data received from a user or from the electric vehicle to be charged.

3. The electric vehicle charging station of claim 1, wherein the DC charging outputs comprise a 600 VDC fast charging output.

4. The electric vehicle charging station of claim 1, wherein the AC charging outputs each comprise an AC Level 2 charging output.
